(19) United States
(12) Patent Application Publication
(10) Pub. No.: US 2009/0126642 A1
(43) Pub. Date: May 21, 2009

(54) LITTER BOX ENCLOSURE

(75) Inventors: Bruno J. Coccia, Rochester, NY (US); Duane Schweitz, Pittsford, NY (US)

Correspondence Address: BROWN & MICHAELS, PC;400 M & T BANK BUILDING, 118 NORTH TIOGA ST, ITHACA, NY, 14850, US

(73) Assignee: SCHOCCIA, INC., Rochester, NY (US)

(21) Appl. No.: 11/941,446

(22) Filed: Nov. 16, 2007

(51) Int. Cl. A01K 29/00

(52) U.S. Cl. 119/165; 119/161

(57) ABSTRACT

The litter box enclosure minimizes transfer of litter, dust, waste, and odor from the litter pan into nearby areas. The litter box enclosure preferably includes a cardboard construction with a removable cover and floor. The floor is preferably wax-coated to provide moisture resistance. The enclosure and the entry are preferably sized to provide the cat with a healthy environment while preventing small children and medium to large dogs from accessing the litter pan. The enclosure preferably includes a doormat near the entry to provide a comfortable, safe area for cats to rest and clean their paws of any stray litter, waste, or dust before leaving the enclosure. The enclosure also preferably has at least one odor absorption unit to minimize odor in the enclosure.

### BACKGROUND OF THE INVENTION

1. Field of the Invention

The invention pertains to the field of litter boxes. More particularly, the invention pertains to a container to contain litter pans.

2. Description of Related Art

Cat litter pans are known in the art. Cat litter pans are unsightly, smelly, and dirty. Litter pans allow litter, dust, waste, and odor to spread into nearby areas, posing potential health risks to humans. Litter pans also expose other pets, such as dogs, and children to the dirty litter, thereby posing further health risks.

Enclosures for cat litter pans are also known in the art. These enclosures are typically made of plastic. These enclosures reduce, but do not eliminate, litter, dust, waste, and odor transfer into nearby areas. They are also small, cramped, and unhealthy for cats, and they make cleaning the litter pan more difficult for the owner.

There is a need in the art for a cat litter pan enclosure that provides a healthy, safe environment for cats, other pets, and humans.

### SUMMARY OF THE INVENTION

The litter box enclosure minimizes transfer of litter, dust, waste, and odor from the litter pan into nearby areas. The litter box enclosure preferably includes a cardboard construction with a removable cover and floor. The floor is preferably wax-coated to provide moisture resistance. The enclosure and the entry are preferably sized to provide the cat with a healthy environment while preventing small children and medium to large dogs from accessing the litter pan. The enclosure preferably includes a doormat near the entry to provide a comfortable, safe area for cats to rest and clean their paws of any stray litter, waste, or dust before leaving the enclosure. The enclosure also preferably has at least one odor absorption unit to minimize odor in the enclosure.

### BRIEF DESCRIPTION OF THE DRAWINGS

FIG. 1 shows an outside view of a litter box enclosure in an embodiment of the present invention.

FIG. 2 shows an exploded view of the litter box enclosure of FIG. 1.

FIG. 3 shows a top view of footprints of litter pans in a litter box enclosure of the present invention.

FIG. 4 shows an outside view of a litter box enclosure with a litter pan in an embodiment of the present invention.

FIG. 5 shows an exploded view of the litter pan and litter box enclosure of FIG. 4.

### DETAILED DESCRIPTION OF THE INVENTION

A litter box enclosure of the present invention contains and conceals a litter pan. The litter box enclosure includes a large structure, including a floor, sides, and a cover, sized to completely enclose any typical litter pan. The structure is preferably made of cardboard, but may be made of any durable, inexpensive, and disposable material. The enclosure keeps the litter pan out of sight and prevents litter, dust, and odor from escaping onto the floor and into the air and other surrounding areas. The interior space of the enclosure is preferably sized to allow cats to extend their tails when using the litter pan, thereby reducing the likelihood of arthritis and infections in the cats, which are commonly-known problems associated with small plastic enclosed litter boxes.

The enclosure contains an entry hole to allow cats to enter the interior space. The entry hole preferably has an arched top and a straight bottom and is preferably sized to prevent medium and large dogs from entering. The entry hole is preferably about seven inches wide and about nine inches high at the peak of the arch. This prevents dogs in the household from making a mess with the litter. The size of the entry hole also preferably prevents infants and toddlers from being exposed to fecal matter and reduces pregnant women's exposure to litter dust, which can cause health problems. The bottom of the entry hole is preferably raised above the level of the interior floor of the enclosure such that kittens cannot crawl over the lip of the entry hole, thereby making the enclosure an ideal location to birth kittens, since the interior space is dark and protected. Because the enclosure is disposable and inexpensive, the enclosure, or even just the floor unit of the enclosure, can be easily disposed of and replaced after it is used to deliver kittens.

In a preferred embodiment of the present invention, the enclosure includes several features to improve the environment around the litter pan. A carpet strip, for example a kitty carpet or other litter box carpet, across the entry area aids in absorption of odor and dust and provides a doormat for cats to wipe their paws prior to exiting the enclosure and entering the household. Other materials for the doormat include, but are not limited to, foam, carpet padding, or any other surface having static cling to draw litter dust from a cat's paws such that the doormat reduces the amount of litter leaving the enclosure on the cats' paws. The doormat preferably covers substantially the entire width of the floor. The doormat is preferably about a foot wide to provide a sufficient width for a cat to lie on the doormat. Two pieces of charcoal, placed under the corners of the litter pan, aid in odor absorption, thereby providing a more pleasant environment in and near the enclosure. Alternatively, baking soda or any other odor or moisture absorption material may be used in place of the charcoal.

The floor is preferably constructed of moisture-resistant cardboard to prevent errant sprays from compromising the integrity of the enclosure. The moisture resistance is preferably in the form of a wax coating, but any treatment to make the cardboard moisture-resistant may be used within the spirit of the present invention. The sides and cover are also preferably constructed of cardboard. The sides may be wax-coated for some applications, but generally a wax coating is not necessary for the sides or the cover. The cardboard construction makes the enclosure inexpensive and regularly replaceable once the odor absorption or other features have lessened in utility. The materials forming the floor, sides, and cover are preferably interlocking in the assembled state. The cardboard construction also allows the enclosure to be disposed of easily without exposing the owner to germs in the enclosure, thereby preventing infections. In one embodiment, the exterior of the enclosure is white on the outside in order to match any decor and may be adorned with paint, markers, decals, fabrics, wallpaper, or other decorative touches to personalize the unit, or in order to match the decor of the room in which it is placed. Alternatively, the exterior of the enclosure may come with a decorative design to provide the enclosure with a more appealing appearance.

FIG. 1 shows an external view of the enclosure 10 in an embodiment of the present invention. A middle section 11, which is preferably cardboard, defines the interior space of the enclosure. The interior space is preferably substantially rectangular. In one embodiment, the dimensions of the enclosure are approximately 18″ wide×28″ long×18″ high. The enclosure completely encloses any typical litter pan. A small entry 12, which is preferably arched at the top, allows cats to access the interior space. As shown in FIG. 1, the entry is preferably near a corner on one of the long sides of the enclosure. The entry may, however, be alternatively located elsewhere along the sides of the enclosure. A removable cover 14 with a lip 16, which is preferably made of cardboard, conceals the litter pan inside the enclosure, covers the interior space, and allows the owner to access and clean the interior space of the enclosure. The enclosure 10 also includes a floor 20, which is not visible in FIG. 1 but is located at the bottom of the middle section.

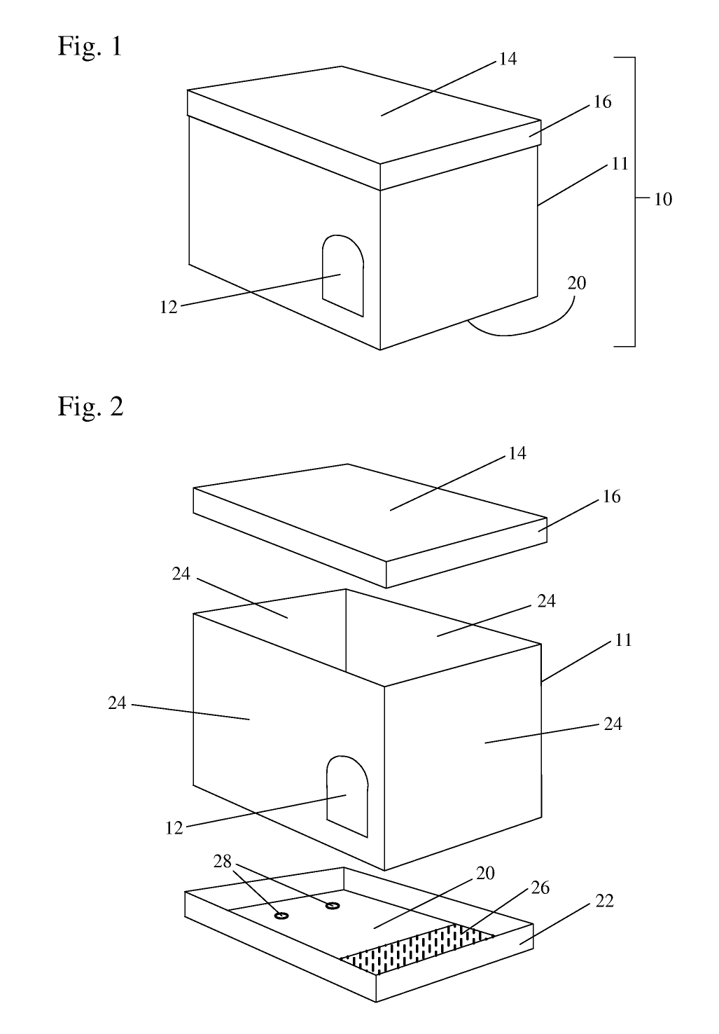

FIG. 2 shows an exploded view of the enclosure of FIG. 1. The floor 20 of the enclosure is preferably wax-coated cardboard and has a lip 22 to contain any litter, urine, or feces not in the litter pan (not shown in FIG. 2). The wax coating is preferably on at least the top surface of the floor 20 and the inward-facing surfaces of the lip 22. The wax coating prevents litter, dust and odor from escaping the enclosure and onto the surrounding floor and other areas. The floor 20 is preferably separable from the middle section 11 of the enclosure, so that it may be replaced without replacing the cardboard sides 24, since the floor becomes dirty more quickly than the sides 24. Preferably, the middle section 11 has an open top for the cover and an open bottom for the floor 20 to be inserted. Alternatively, the floor 20 may sit on top of a bottom surface integral with the sides 24 of the enclosure. Although the lip 22 may be placed outside the sides 24 in the assembled enclosure, the lip 22 is preferably located inside the sides 24 with minimal clearance to minimize materials going between the lip 22 and the sides 24.

A doormat 26 is preferably placed on the floor 20 of the enclosure near where the entry 12 is located in the assembled enclosure. In a preferred embodiment, the doormat 26 is a carpet strip. Odor absorption units 28 to aid in the absorption of odors are preferably placed away from the entry in the area near or under where the litter pan is to be located. Although the odor absorption units 28 are located on the floor 20 in FIG. 2, they may be placed anywhere near the litter pan in the enclosure, as long as they are not accessible to the cats, within the spirit of the present invention. In a preferred embodiment, the odor absorptions units 28 are in the form of two briquettes of charcoal.

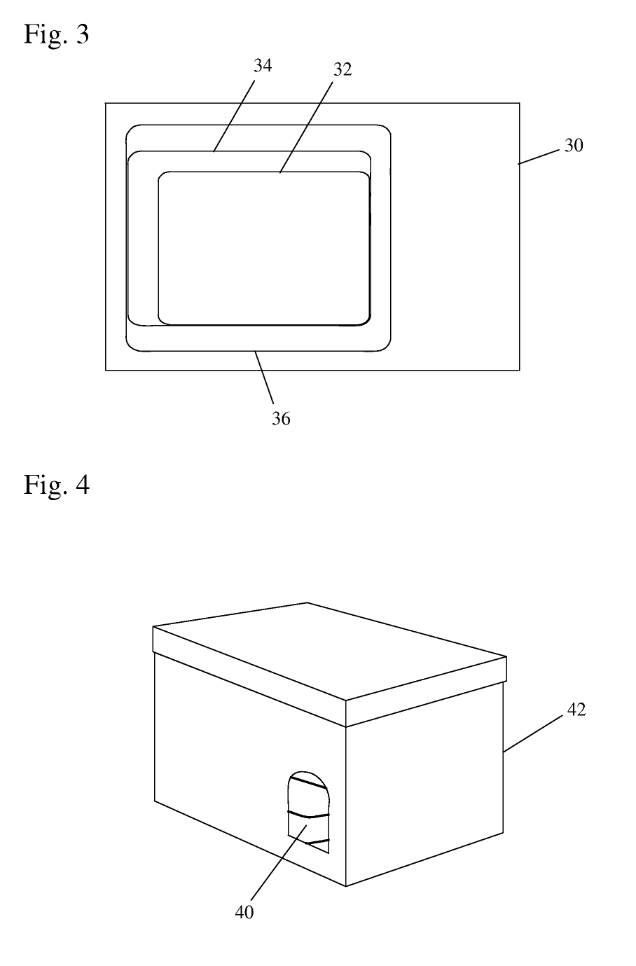

The enclosure is preferably sized to fit a range of litter pans already commercially available on the market. FIG. 3 shows the footprints of three different sizes of commercially available litter pans 32, 34, 36 on the floor 30 of the enclosure in a preferred embodiment of the present invention. In this embodiment, the floor 30 has dimensions of 18″×28″. The small-sized litter pan 32 has dimensions of 10.4″×14.1″. The medium-sized litter pan 34 has dimensions of 12″×16″. The large-sized litter pan 36 has dimensions of 15.3″×18.5″. FIG. 4 shows an external view of a litter pan 40 in an assembled enclosure 42 of the present invention.

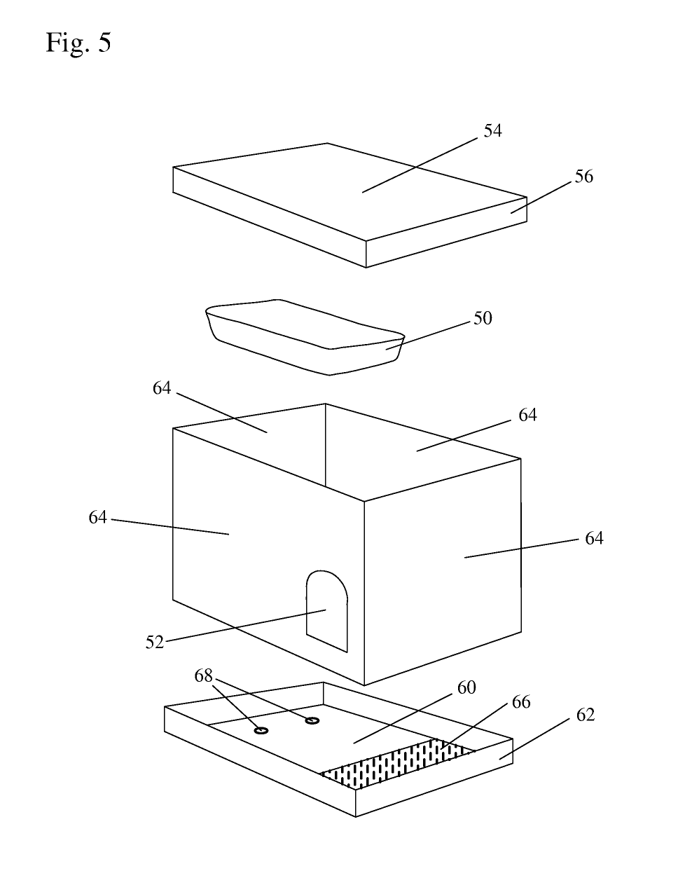

FIG. 5 shows an exploded view of an enclosure in an embodiment of the present invention with a litter pan 50. The enclosure is easily assembled and may be provided in pieces as a kit. The enclosure may be sold with or without the litter pan 50. The sides 64 are preferably flattened when packaged to reduce packing size. The entry 52 is preferably pre-cut to size and may be available in different sizes for different-sized cats. To assemble the unit, the user unflattens the sides 64 to form the rectangular shape of the enclosure. The cover 54 and the floor 60 may come flattened or with the lips 56, 62, respectively, pre-formed. Although the doormat 66 and odor absorption units 68 may come permanently affixed to the floor 60 or reversibly attachable to the floor by Velcro® strips or other reversible means, the doormat 66 and odor absorption units are preferably shipped loose and placed on the assembled floor unit by the user. This allows the user to replace the floor unit, the doormat, or the odor absorption units separately and independently as necessary when each loses its effectiveness. The user places the sides 64 over the lips 62 of the assembled floor unit. The user then places the litter pan 50 filled with litter on the floor 60 near or on the odor absorption units 68. Finally, the user places the lips 56 of the assembled cover unit over the top edges of the sides 64 to complete assembly of the enclosure. Additional floor units, doormats, or odor absorption units may be provided with the original enclosure unit or sold separately, so that the user can replace the floor 60 without replacing the entire enclosure.

Although the present invention has been described primarily in terms of embodiments for general use by cats, the design may be modified for other uses within the spirit of the present invention. The layout, design, dimensions, and features of the enclosure may be modified for use by other litter-using animals, including, but not limited to, rabbits and ferrets. The enclosure may also be modified specifically for use as a birthing place for litters.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A litter box enclosure comprising:
a middle section comprising a plurality of sides, one of the sides having an entry hole;
a cover removable from the top of the middle section;
a floor removable from the middle section and comprising a floor lip extending upward from the edges of a floor surface of the floor that interlocks with the middle section; and
a doormat located on the floor surface near the entry hole;
wherein the enclosure is sized to fit a litter pan on the floor surface not covered by the doormat.

2. The enclosure of claim 1, wherein the cover comprises a cover lip extending downward from the edges of a cover surface of the cover to fit around the top of the sides.

3. The enclosure of claim 1, wherein the floor lip fits inside the bottom of the sides.

4. The enclosure of claim 1, wherein the middle section, the cover, and the floor are made of cardboard, and wherein the floor is wax-coated to provide moisture resistance.

5. The enclosure of claim 1, wherein the doormat comprises a carpet strip.

6. The enclosure of claim 1 further comprising at least one odor absorption unit.

7. The enclosure of claim 6, wherein the odor absorption unit comprises a briquette of charcoal.

8. The enclosure of claim 6, wherein the odor absorption unit is located on the floor surface.

9. The enclosure of claim 8 further comprising the litter pan located on the floor surface near the odor absorption unit.

10. The enclosure of claim 1 further comprising the litter pan located on a part of the floor surface not covered by the doormat.

11. The enclosure of claim 10, wherein the middle section is sized to have a height such that a cat can extend its tail while using the litter pan without constraint by the cover in the enclosure.

12. The enclosure of claim 1, wherein the entry hole is approximately 7″ wide and approximately 9″ high to allow a cat and to prevent a medium dog or a small child from entering the enclosure.

13. The enclosure of claim 1, wherein the entry hole is raised on the one side to a height above the floor surface such that a newborn kitten can not climb out of the enclosure.

14. A litter box enclosure for promoting the health and well-being of cats, other pets, and humans, the enclosure comprising:
a middle section comprising a plurality of sides, one of the sides having an entry hole;
a cover removable from the top of the middle section;
a floor removable from the middle section and comprising a floor lip extending upward from the edges of a floor surface of the floor that interlocks with the middle section;
a doormat located on the floor surface near the entry hole for cats to rest and clean their paws of any stray litter, waste, or dust before leaving the enclosure; and
at least one odor absorption unit located within the enclosure for reducing odor in the enclosure;
wherein the middle section, the cover, and the floor are made of cardboard and the floor is wax-coated to provide moisture resistance;
wherein the enclosure is sized to fit a litter pan on the floor surface in an area not covered by the doormat; and
wherein the sides are sized to have a height such that cats can extend their tails upward while using the litter pan without constraint by the cover.

15. The enclosure of claim 14, wherein the cover comprises a cover lip extending downward from the edges of a cover surface of the cover to fit around the top of the sides.

16. The enclosure of claim 14, wherein the floor lip fits inside the bottom of the sides.

17. The enclosure of claim 14 further comprising the litter pan located on the floor surface.

18. A kit for enclosing a litter pan, the kit comprising:
an enclosure comprising:
a middle section comprising a plurality of sides, one of the sides having an entry hole;
a cover section removable from the top of the middle section; and
a floor section comprising a floor lip extending upward from the edges of a floor surface of the floor section and sized to fit inside the bottom of the sides;
wherein the middle section, the cover section, and the floor section are made of cardboard and the floor surface is wax-coated to provide moisture resistance;
a doormat to be placed on the floor surface of the enclosure near the entry hole; and
at least one odor absorption unit to be placed within the enclosure for reducing odor in the enclosure;
wherein the middle section, the cover section, and the floor section are sized to fit the litter pan on the floor surface in an area not covered by the doormat when the kit is assembled; and
wherein the sides are sized to have a height such that cats can extend their tails upward while using the litter pan without constraint by the cover when the kit is assembled.

19. The enclosure of claim 18, wherein the cover comprises a cover lip extending downward from the edges of a cover surface of the cover to fit around the top of the sides when the kit is assembled.

20. The kit of claim 18 further comprising the litter pan to be located on the floor surface when the kit is assembled.
